(19) United States
(12) Patent Application Publication
(10) Pub. No.: US 2010/0080392 A1
(43) Pub. Date: Apr. 1, 2010

(54) Key Management In Storage Libraries

(76) Inventors: Stanley S. Feather, Berthoud, CO (US); Curtis C. Ballard, Eaton, CO (US); Jonathan P. Buckingham, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/243,914

(22) Filed: Oct. 1, 2008

(51) Int. Cl. H04L 9/06

(52) U.S. Cl. 380/277

(57) ABSTRACT

Embodiments include methods, apparatus, and systems for managing encryption keys in a storage library. One method includes using a tape library to determine which key manager is selected for data encryption operations to a tape drive when multiple different key managers exist in a storage system.

### BACKGROUND

Storage automation systems, such as data cartridge storage systems, include a host computer and a data storage device. The data storage device typically comprises a cartridge storage element, input/output (I/O) components, and a moveable cartridge access component, sometimes referred to as a “picker.” The cartridge storage element stores a plurality of data cartridges in an array, and each data cartridge in the array has an associated storage position within the cartridge storage element.

During operation, the data storage device receives read and write requests from the host computer. Data stored on the cartridges can be encrypted. The host computer sends the encryption key and the data to the data cartridge drive. In this operation, the host controls both the encryption keys and data flow.

The timely management of a large number of encryption keys in multiple drives is a difficult task. Hosts need special key management capabilities, and further problems arise if multiple or different types of hosts attempt to manage encryption keys for data in the same library. Furthermore, if keys can be delivered to cartridge drives through different ports, then unintended operations can occur in which a key is overwritten or lost, and the wrong key is used to encrypt or decrypt data.

### BRIEF DESCRIPTION OF THE DRAWINGS

FIG. 1 is a storage system having a cartridge library in accordance with an exemplary embodiment of the present invention.

FIG. 2 is an exemplary flow diagram for controlling key management and selecting a tape library as key manager for encryption operations in accordance with an exemplary embodiment of the present invention.

FIG. 3 is an exemplary flow diagram for controlling key management and selecting a host computer as key manager for encryption operations in accordance with an exemplary embodiment of the present invention.

FIG. 4 is an exemplary storage system having a tape library in accordance with an exemplary embodiment of the present invention.

FIG. 5A is a perspective view of a tape drive in accordance with an exemplary embodiment of the present invention.

FIG. 5B is a rear plan view of the tape drive of FIG. 5A in accordance with an exemplary embodiment of the present invention.

### DETAILED DESCRIPTION

Embodiments in accordance with the present invention are directed to apparatus, systems, and methods for controlling encryption key management contention in storage libraries. One embodiment controls which key manager is selected for data encryption operations when multiple key managers are present in the storage environment.

In one exemplary embodiment, a feature in the tape drive enables or disables which key management functions which are supported via a specific port. This feature is controlled by the tape library, or other management device associated with the tape library. By way of example, the first time the tape library and tape drive are powered up, the tape drive allows key management through a specific interface, by default. The library administrator or a security officer may select an alternative interface to be used for key management. This selection is communicated to the tape drive via a manageability interface. Once that selection has been made, the selection persists until changed again by the administrator. The selection can be maintained through persistent storage in the tape drive or persistently reapplied by the management device each time the tape drive is powered up.

The tape drive uses this setting to restrict which port can be used to send encryption keys. When a request is made via the selected port to change the key, that request is successful. When a request is made via the de-selected port to change the encryption key, that request is rejected with an error message.

Exemplary embodiments enable the administrator or a security officer to select key management via out-of-band paths (such as the manageability interface on the tape drive), without introducing contention if another key manager is later introduced on the in-band path (for example, on the fibre channel SAN).

For tape drives that support encryption, exemplary embodiments enable cryptographic keys to be sent via in-band (for example, through the primary data ports) or out-of-band (for example, through a different port). The tape library controls or selects which particular port or path will function to receive the encryption keys. Therefore, sources of keys must originate through a single port. As such, simultaneous contention through multiple ports does not occur. The tape drive is locked into a single key management port so keys are not received through multiple different ports at the same time. Instead, keys are received through a single designated port, restricting management of the keys to occur from a single designated key manager.

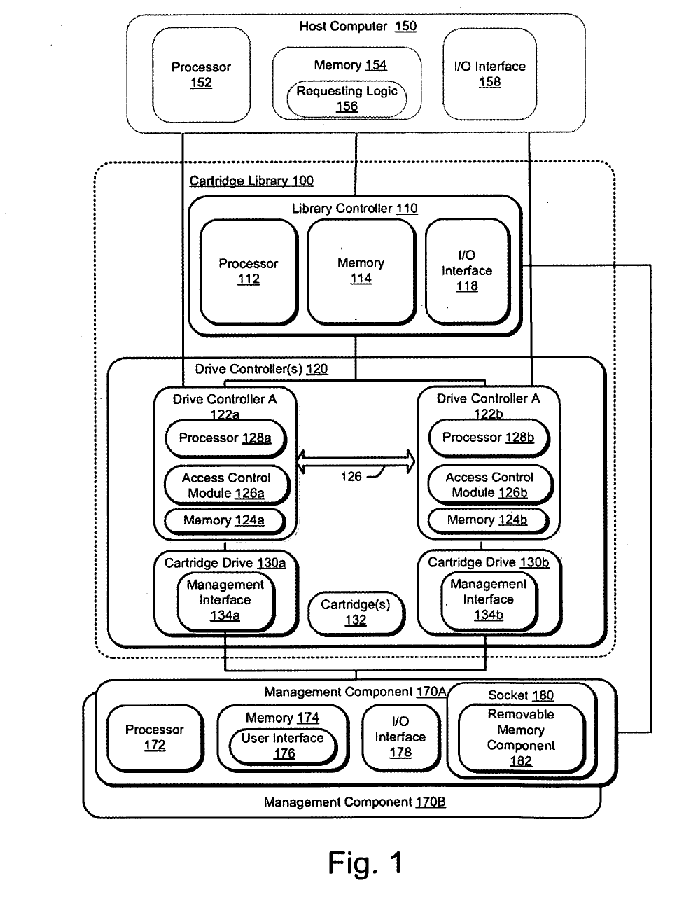

FIG. 1 is an exemplary storage system having a cartridge library 100 in accordance with an exemplary embodiment of the present invention. In one embodiment, the cartridge library 100 is a tape library that includes at least one library controller module 110, including a processor 112 which is coupled to a memory 114, an I/O interface 118, and one or more cartridge drive controllers 120. The library controller 110 is coupled to the cartridge drive controllers 120 via one or more interface buses such as, e.g., an RS422 bus or an inter-integrated circuit (I2C) bus. It is noted that the library controller 1′10 can be embodied as a separate component (as shown), or can be accessed through one or more of the drive controllers 120, or within a separate host computer 150.

In one embodiment, the library controller 110 is implemented as a software module that runs on a general purpose processing unit of the tape library, or as a special-purpose chipset.

In some embodiments, the host computers 150 connect to the drive controllers and the library controller by another bus. By way of example, the host computers 150 connect to the library and drives using buses with SCSI protocols, and the library connects to the drives using RS422.

The cartridge drive controllers 120 coordinate data transfer to and from the one or more cartridge drives 130a-130b. In one embodiment, the library includes two cartridge drive controllers: a first cartridge drive controller 122a and a second cartridge drive controller 122b. Cartridge drive controllers 122a and 122b have respective processors 128a and 128b, respective memories 124a and 124b, and respective access control modules 126a and 126b. Processors 128a, 128b can be implemented as general purpose processors that execute logic instructions in the respective memories 124a, 124b, or can be implemented as special purpose processors adapted to implement logic instructions embodied as firmware, or as ASICs. The memories 124a and 124b can be implemented as battery-backed, non-volatile memory, such as flash memory or one or more of random access memory (RAM), dynamic RAM (DRAM), synchronous DRAM (SDRAM), and the like. Although only two controllers 122a and 122b are shown and discussed generally herein, aspects of this invention can be extended to other multi-controller configurations where more than two controllers are employed.

The cartridge drives 130a, 130b are configured to receive a tape cartridge 132. Input/Output (I/O) operations requested by host computer 150 are executed against data stored in the tape cartridges 132.

In some embodiments, tape library 100 is coupled to plural management components 170A and 170B. In one embodiment, the management components 170A and 170B are separate from each other and can be located internal or external to the tape library 100. By way of example, management components 170A, 170B are embodied as an integrated computing device such as, e.g., a blade server implemented on a printed circuit board (PCB) that couples to an expansion slot in tape library 100. Alternatively, the management components are embodied as a stand-alone computing device such as, e.g., a server, coupled to tape library 100 via a communication link, such that management components are coupled to multiple tape libraries 100.

Each management component 170A and 170B includes a processor 172, a memory module 174, and an I/O interface 178. Processor 172 can be embodied as a general purpose computer processor. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. Memory 174 includes one or more of random access memory (RAM), dynamic RAM (DRAM), synchronous DRAM (SDRAM), and the like. For example the memory 174 includes an operating system to manage operations of the management component. The operating system can include (or manage) one or more communication interfaces such as I/O interface 178 to receive data packets and/or data streams from a remote source. The I/O interface 178 can include a parallel port (e.g., a small computer system interface (SCSI) port), Ethernet, or other type of known or future developed data communication port.

In some embodiments management component includes a removable non-volatile memory component (RNMC) 182 coupled via a socket 180 that provides a conductive connection between the RNMC 182 and other components of the management component. The RNMC 182 can store operational and control management data associated with the tape library 100.

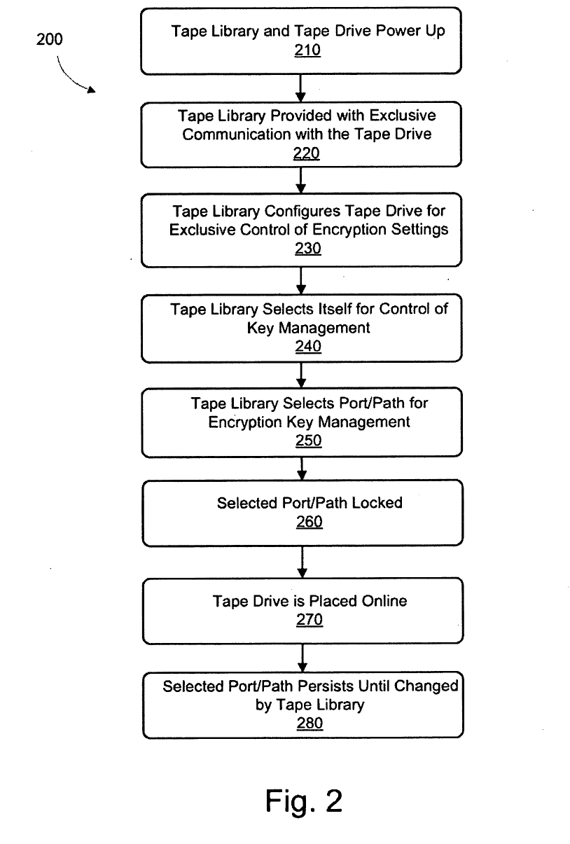

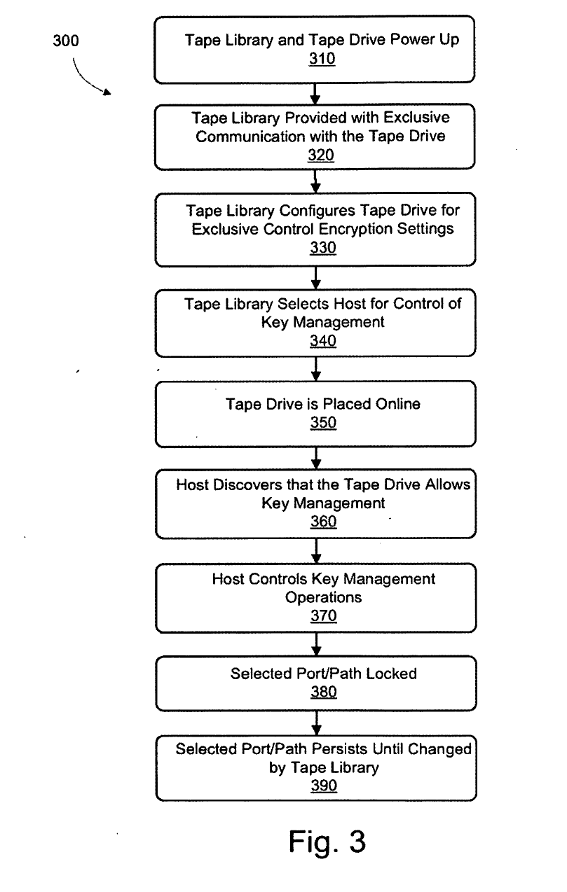

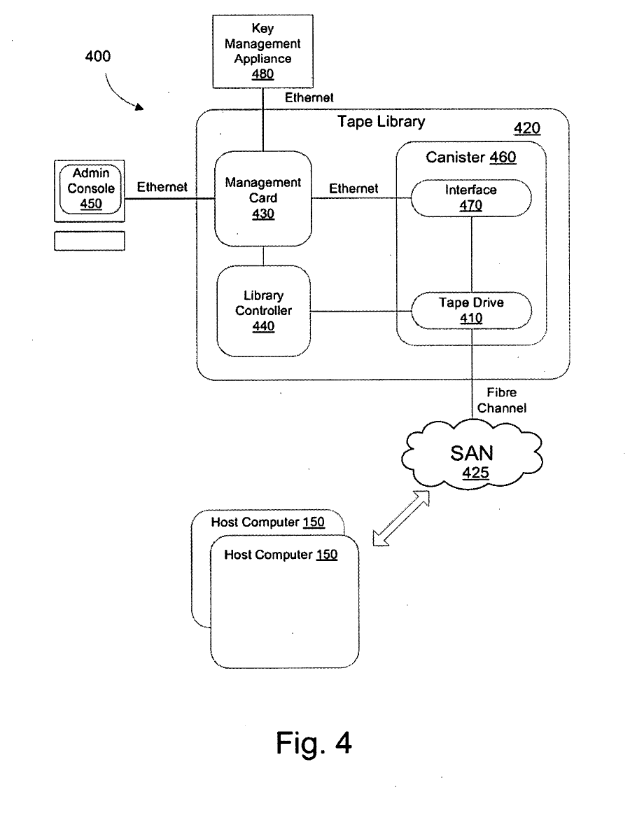

Exemplary embodiments in accordance with the invention are further discussed in connection with FIGS. 2 and 3. Specifically, FIGS. 2 and 3 are exemplary flow diagrams for controlling and managing encryption key operations to storage devices in storage systems, such as storage systems discussed in FIGS. 1 and 4.

FIG. 2 is an exemplary flow diagram 200 for controlling key management and selecting a tape library as key manager for encryption operations in accordance with an exemplary embodiment of the present invention.

According to block 210, the tape library and tape drive power up.

According to block 220, the tape library is initially provided with exclusive communication with the tape drive. In this mode, host computers are not able to communicate with the tape drive.

According to block 230, the tape library configures the tape drive for exclusive control of encryption settings. This configuration will ensure that the tape drive does not receive encryption keys through multiple different ports. Confusion or discrepancies will therefore not occur as to which electronic device (for example, tape library or host) has control to manage the encryption keys.

According to block 240, the tape library has discretion to select who will have exclusive control of the keys as key manager. For illustration, the tape library selects itself for control of key management. The tape library sends the tape drive a command to configure the tape drive so the tape library has exclusive access and control of encryption settings.

According to block 250, the tape library (now being selected as exclusive control of key management operations) selects the port and/or path of the tape drive for encryption key management. By way of example, the tape library selects between plural different ports or paths, such as out-of-band or in-band paths. By way of further example, such ports include, but are not limited to, a data port that connects to a host (such as a SCSI or fibre channel port) or a management port (such as an automation drive interface port (ADI)).

According to block 260, the selected port or path is locked. In one embodiment, the port and/or path are locked and cannot be changed by other devices (such as hosts) until or unless such change is authorized by the tape library. The tape drive uses this port/path setting to restrict which port is used to send encryption keys to the tape drive. When a request is made via the selected port to change the current encryption key, the request is allowed. By contrast, when a request is made via a non-selected port to change the current encryption key, the request is denied and notification (for example, an error message) is sent to the requestor, user, or the like.

In one exemplary embodiment, a user (such as the library administrator) selects which port/path is used for key management. This selection is communicated to the tape drive through a management port on the tape drive. This selection persists until changed by the administrator. This persistence may be implemented in either the drive, or the library.

According to block 270, the tape drive is placed online. By way of example, the tape drive becomes capable of responding to discovery requests, and read/write commands. In some implementations a notice may also be transmitted to the host that the tape drive is online and available for read/write commands.

According to block, 280, the selected port and/or path persists until changed (for example, by the tape library). In one embodiment, only the tape library and/or an administrator have authorization to change key management settings and the selected port/path. As such, a host computer would be locked from making such a change unless first authorized to do so by the tape library or administrator.

FIG. 3 is an exemplary flow diagram 300 for controlling key management and selecting a host computer as key manager for encryption operations in accordance with an exemplary embodiment of the present invention.

According to block 310, the tape library and tape drive power up.

According to block 320, the tape library is initially provided with exclusive communication with the tape drive. In this mode, host computers are not yet able to communicate with the tape drive.

According to block 330, the tape library configures the tape drive for exclusive control of encryption settings. This configuration will ensure that the tape drive does not receive encryption keys through multiple different ports. Confusion or discrepancies will therefore not occur as to which electronic device (for example, tape library or host) has control to manage the encryption keys.

According to block 340, the tape library has discretion to select who will have exclusive control of the keys as key manager. For illustration, the tape library waives its authorization to manage the encryption keys and selects a host computer for control of key management. The tape library sends the tape drive a command to configure the tape drive so that host computers have exclusive access and control of encryption settings.

According to block 350, the tape drive is placed online. By way of example, the tape drive becomes capable of responding to discovery requests, and read/write commands. In some implementations a notice may also be transmitted to the host that the tape drive is online and available for read/write commands.

According to block 360, a host discovers the tape drive and discovers the tape drive will allow key management by hosts.

According to block 370, the host computer now issues commands to control key management operations. The tape drive may optionally allow the host to select the port and/or path of the tape drive for encryption key management. Alternatively, the tape drive may automatically lock key management to the port which the host used to request control of key management. If the host computer is allowed to select between plural different ports or paths, such ports could include, but are not limited to, a data port that connects to a host (such as a SCSI or fibre channel port), or a management port (such as an automation device interface port (ADI)).

According to block 380, the selected port or path is locked by the tape drive. In one embodiment, the port and/or path are locked and cannot be changed by other devices (such as other hosts) until or unless such change is authorized by the tape library or the library administrator, or until the host releases control of key management. The tape drive uses this port/path setting to restrict which port is used to send encryption keys to the tape drive. When a request is made via the selected port to change the current encryption key, the request is allowed. By contrast, when a request is made via a non-selected port to change the current encryption key, the request is denied and notification (for example, an error message) is sent to the requestor, user, or the like.

In one exemplary embodiment, a user (such as the library administrator) selects which port/path is used for key management. This selection is communicated to the tape drive through a management port on the tape drive. This selection persists until changed by the administrator.

According to block, 390, the selected port and/or path persists until changed (for example, by the tape library) or until the host using that path releases control of key management. In one embodiment, only the tape library and/or an administrator have authorization to change key management settings and the selected port/path. As such, a host computer would be locked from making such a change unless first authorized to do so by the tape library or administrator.

In one exemplary embodiment, if the tape library has exclusive control of key management operations, then a host is prohibited from also having control of such operations. In this situation, the tape library has authorization to release control to a host computer. With such authorization, a host can select and lock the key management port but would be prohibited from permanently locking control from the tape library (for example, assuming the tape library or an administrator requested the host to relinquish such control).

In one embodiment, the tape library determines or selects whether the tape library itself or a host computer will control and manage the encryption keys and settings. Further, various defaults can be established (for example, a default to allow a host to send keys through a primary port of the tape drive). The tape drive can also accept keys from the tape library but the tape library is first given exclusive access to make configurations of key management operations and decisions during initialization.

FIG. 4 is an exemplary storage system 400 in accordance with an exemplary embodiment of the present invention. The storage system includes a tape library 420 connected to an administrative console 450 and one or more host computers 150 via one or more networks (for example, shown as a storage area network 425 or SAN).

The tape library 420 includes a canister 460 housing an interface 470 and tape drive 410. A management card 430 couples to a library controller 440, canister 460 (for example, via an Ethernet connection), and the administrative console 450 (for example via an Ethernet connection). A key management appliance 480 couples (for example via an Ethernet connection) to the tape library 420. The key management appliance 480 can be internal or external to the tape library. Furthermore, the key management appliance 480 is not required to couple to a management card but can connect directly to the tape drive.

In one exemplary embodiment, the administrative console 450 enables a user or administrator to select and/or administer encryption policies in the key manager 480 that apply to the tape library 420 and its components. In another embodiment, the key manager may be internal to the library. The encryption policies can be independent of the software at the hosts writing the data. As such, hosts are not required to have special key management capabilities to read and write encrypted data to a tape drive.

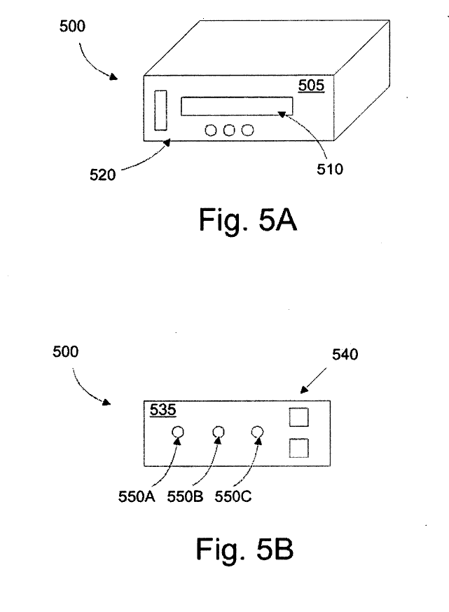

FIGS. 5A and 5B show one exemplary removable media device, such as a tape drive 500 in accordance with embodiments of the invention. Generally, the tape drive has a front side or panel 505 that includes a tape access door 510 and various controls and displays 520. A back side or panel 535 includes various connectors, ports, cable attachments, power, etc. (shown generally at 540).

In one exemplary embodiment, the tape drive 500 includes plural ports 550A-550C. At least one of these ports is a data port, and one port is used for device management, including encryption management. The management and data ports are separately provided such that keys may be provided to enable encryption and decryption without interfering with data traffic transmitting through the data port.

By way of example, one of the ports functions as an out-of-band path while another port functions as an in-band path. As discussed in connection with FIGS. 2 and 3, the selected key manager (for example, the tape library or host) determines which port functions for key management operations. For illustration, port 550A is the out-of-band port, and port 550B is an in-band port. When a key is needed to encrypt or decrypt data, the request and key are sent through the port 550A which is configured not to receive data from host computers. At the same time, data being read from and/or written to the tape drive is transmitted through the port 550B which is configured to receive data from host computers. In this configuration, encryption keys are securely communicated and transmitted to the tape drive using a separate, distinct path and/or port without interfering with data being transmitted to or from a host.

In one embodiment, the tape drive notifies the key manager through an out-of-band path or port when an encryption key is required. The selected key manager obtains the requested key from a source (for example, a source internal to the tape library or a source external to the tape library). The key manager then transmits the requested key to the tape drive through the out-of-band path or port. The tape drive then notifies the key manager through this out-of-band path or port when usage of the key is completed.

In one embodiment, the encryption keys are sent independent of the data. For example, encryption keys are sent through an out-of-band path. By way of example, the encryption keys and data are transmitted down different paths to the cartridge or tape drive. Since the encryption keys and data are separated, the encryption keys are more secure (for example, as opposed to transmitting the keys and data along the same paths and/or through the same ports).

Exemplary embodiments provide key management operations through a single port of the tape drive. A user can re-configure which port, is used for this management, but this configuration persists until changed by the user. Further, in one embodiment, tape drives do not retain their states when removed for replacement. Embodiments thus provide a single point of key management for a given storage library and prevent keys from different key management schemes being intermixed. A coherent process exists to support encryption key management for different software applications and customer requirements.

Keys are managed through the designated port. (such as the AMI, ADI port or the fibre channel (FC), SCSI, or SAS ports). In one embodiment, key management can only be changed through a management API (Application Program Interface) or other designated event (such as a proprietary SCSI command). The selected key management port appears persistent to initiators on any port (across power cycles, resets, firmware downloads, etc.). Further, such key management settings can be retained when a drive is replaced.

In one exemplary embodiment, keys are sent to the tape drive through a command, such as a T10 (SCSI) command. Various methods can be used to alert or notify when a tape drive needs a key. For example, the tape library can repeatedly or periodically request whether the tape drive needs a key. Alternatively, events are used to trigger notice to the tape library or key manager that a key is needed.

Exemplary embodiments provide key management through a specific interface. In one embodiment, this interlace is a specific or predetermined port, but in other embodiments this interface is a type of port. For example, instead of controlling which port on the tape drive is allowed to send encryption commands, the key manager controls which type of port is allowed to send encryption commands. By way of illustration, a tape drive can have two “types” of ports, data ports and management ports. Furthermore, such a tape drive could have multiple data ports (as one type of port) and multiple management ports (as another type of port). If a tape drive has two data ports, then each of these two data ports is controlled as one port type. In this instance, both of the two data ports can accept encryption commands.

Embodiments in accordance with the present invention are utilized in a variety of systems, methods, and apparatus. For illustration, exemplary embodiments are discussed in connection with a tape library. Exemplary embodiments, however, are applicable to other types of storage systems, such as storage devices using cartridges, hard disk drives, optical disks, or movable media.

In one exemplary embodiment, one or more blocks in the flow diagrams are automated. In other words, apparatus, systems, and methods occur automatically. As used herein, the terms “automated” or “automatically” (and like variations thereat) mean controlled operation of an apparatus, system, and/or process using computers and/or mechanical/electrical devices without the necessity of human intervention, observation, effort and/or decision.

In exemplary embodiments, the architectures and methods can be implemented in tape storage libraries such as the tape storage libraries described in U.S. Pat. No. 5,926,341; 6,028,733; or 6,421,306, commonly assigned to the assignee of the present application, the disclosures of which are incorporated by reference herein in their entirety.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive, flash memory, or hard drive. The software programming code is embodied or stored on any of a variety of known media for use with a data processing system or in any memory device such as semiconductor, magnetic and optical devices, including a disk, hard drive, CD-ROM, ROM, flash memory, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
using a tape library to determine which key manager is selected for data encryption operations to a tape drive when multiple different key managers exist in a storage system.

2) The method of claim 1 further comprising, selecting a single port on the tape drive for receiving encryption keys to encrypt and decrypt data.

3) The method of claim 1 further comprising, transmitting an encryption key to the tape drive from a key manager selected by the tape library.

4) The method of claim 1 further comprising:
selecting on the tape drive a single interlace used for key management;
maintaining the single interface for key management until changed by an administrator.

5) The method of claim 1 further comprising:
selecting a port on the tape drive for receiving encryption keys to encrypt and decrypt data;
storing selection of the port in a component of the tape library.

6) The method of claim 1 further comprising:
transmitting an encryption key through a first port on the tape drive;
transmitting data through a second port on the tape drive.

7) A computer readable medium having instructions for causing a computer to execute a method, comprising:
selecting, by a tape library, between granting authorization to the tape library to manage encryption keys at a tape drive and granting authorization to a host computer to manage the encryption keys at the tape drive.

8) The computer readable medium of claim 7 further comprising, restricting which port, at the tape drive is authorized to receive the encryption keys.

9) The computer readable medium of claim 7 further comprising:
selecting a single port at the tape drive to receive the encryption keys;
denying requests to change the encryption keys when the requests are sent to ports other than the single port.

10) The computer readable medium of claim 7 further comprising, transmitting data and cryptographic keys along different paths to the tape drive.

11) The computer readable medium of claim 7 further comprising, locking management of the encryption keys to a single port on the tape drive to prevent the encryption keys from entering the tape drive from plural different ports on the tape drive.

12) The computer readable medium of claim 7 further comprising:
allowing a single key manager to manage encryption keys at the tape drive;
continuing to allow the key manager to provide encryption and decryption keys until the key manager releases control, or until a library administrator discontinues access by the key manager.

13) The computer readable medium of claim 7 further comprising, waiving, by the tape library, authorization to manage the encryption keys at the tape library.

14) The computer readable medium of claim 7 further comprising, providing the tape library with exclusive access to encryption control settings for the tape drive before the host computer is notified of the tape drive being online.

15) The computer readable medium of claim 7 further comprising, granting, by the tape library, exclusive control to the host computer to manage the encryption keys.

16) A storage system, comprising:
a tape library that selects a key manager for data encryption operations to a tape drive when multiple different key managers exist in the storage system.

17) The storage system of claim 16, wherein the tape library selects the key manager between one or more host computers and the tape library.

18) The storage system of claim 16, wherein the key manager determines which port on the tape drive receives keys to encrypt and decrypt data.

19) The storage system of claim 16, wherein the tape library has authorization to release control of encryption management operations of the tape drive to a host computer.

20) The storage system of claim 19, wherein the key manager selects a single port on the tape drive to receive encryption keys.
